(19) United States
(12) Patent Application Publication
(10) Pub. No.: US 2008/0133653 A1
(43) Pub. Date: Jun. 5, 2008

(54) APPARATUS AND METHODS OF PROVIDING AND PRESENTING REPRESENTATIONS OF COMMUNICATION EVENTS ON A MAP

(75) Inventors: Kenny Fok, San Diego, CA (US); Clarence C. Wong, Encinitas, CA (US); Eric Chi Chung Yip, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/948,045

(22) Filed: Nov. 30, 2007

Related U.S. Application Data
(60) Provisional application No. 60/868,695, filed on Dec. 5, 2006.

(51) Int. Cl. G06F 15/16

(52) U.S. Cl. 709/203; 709/201

(57) ABSTRACT

Apparatus and methods of providing or presenting data corresponding to communication events occurring on one or more wireless devices include receiving data for a plurality of communication events each corresponding to a location. Further, data corresponding to a map representation having a determined area is generated, wherein the determined area corresponds to a geographic area defined by an extent of the respective locations. Additionally, data corresponding to at least one of an individual representation or a combined representation is generated, wherein each individual representation corresponds to one of the plurality of communication events, and wherein each combined representation corresponds to a combination of at least two of the communication events if a predetermined overlap would exist between their respective individual representations on the map representation.

### CLAIM OF PRIORITY UNDER 35 U.S.C. §119

The present Application for Patent claims priority to Provisional Application No. 60/868,695 entitled “METHOD AND APPARATUS FOR DISPLAYING A LARGE SET OF MOBILE DATA ON MAP MODULE” filed Dec. 5, 2006, and assigned to the assignee hereof and hereby expressly incorporated by reference herein.

### BACKGROUND

The described aspects relate to communication networks, and more particularly, to apparatus and methods of presenting a representation of communication events occurring on one or more wireless devices on a map.

Many communication events relating to the operation of one or more wireless devices occur on a wireless communication network. An example communication event is a telephone call on a wireless device being dropped by a base station, referred to as a call drop. There are many other types of communication events that may occur on wireless communication networks, e.g. an access failure, an idle failure, a successful connection or access success, an out of service event, etc. Various parties, such as network operators, device manufacturers, and component manufacturers, may be interested in various communication events in order to manage a portion of a wireless network or in order to manage wireless device performance.

Because the number of communication events may be numerous and because the communication events may occur in the same location or near one another, it may be time consuming to present the communication events on a map, or difficult to distinguish between the representations for the communication events on the map, or both.

Further, the data representing the communication events may not be located on the computing device where the communication events are to be presented. Such remotely located communication event data may cause usability problems by creating delays while receiving the communication event data.

Thus, it is desired to enhance the presentation of communication event data associated with the operation of one or more wireless devices on a wireless network.

### SUMMARY

The following presents a simplified summary in order to provide a basic understanding of some aspects of the present disclosure. This summary is not an extensive overview and is intended to neither identify key or critical elements nor delineate the scope of such aspects. Its purpose is to present some concepts of the described aspects in a simplified form as a prelude to the more detailed description that is presented later.

In one aspect, a method of providing data related to a communication event occurring on a wireless device comprises collecting data for a plurality of communication events each respectively corresponding to a wireless device or a network device or both, wherein each communication event further corresponds to a respective location. The method further includes generating data corresponding to a map representation having a determined area, wherein the determined area corresponds to a geographic area defined by an extent of the respective locations. Additionally, the method includes generating data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation. Also, the method includes transmitting the generated data corresponding to a map representation and the generated data corresponding to at least one of an individual representation or a combined representation to a requesting computing device for generation of the map representation and at least the one of the individual representation or the combined representation.

In another aspect, at least one processor configured to provide data related to a communication event occurring on a wireless device comprises a first module for collecting data for a plurality of communication events each respectively corresponding to a wireless device or a network device or both, wherein each communication event further corresponds to a respective location. Also, the at least one processor includes a second module for generating data corresponding to a map representation having a determined area, wherein the determined area corresponds to a geographic area defined by an extent of the respective locations. Further, the at least one processor includes a third module for generating data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation. Additionally, the at least one module includes a fourth module for transmitting the generated data corresponding to a map representation and the generated data corresponding to at least one of an individual representation or a combined representation to a requesting computing device for generation of the map representation and at least the one of the individual representation or the combined representation.

In yet another aspect, a computer program product configured to provide data related to a communication event occurring on a wireless device comprises a computer-readable medium comprising instruction. The computer-readable medium includes at least one instruction for causing a computer to collect data for a plurality of communication events each respectively corresponding to a wireless device or a network device or both, wherein each communication event further corresponds to a respective location. Further, the computer-readable medium includes at least one instruction for causing the computer to generate data corresponding to a map representation having a determined area, wherein the determined area corresponds to a geographic area defined by an extent of the respective locations. Also, the computer-readable medium includes at least one instruction for causing the computer to generate data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation. Additionally, the computer-readable medium includes at least one instruction for causing the computer to transmit the generated data corresponding to a map representation and the generated data corresponding to at least one of an individual representation or a combined representation to a requesting computing device for generation of the map representation and at least the one of the individual representation or the combined representation.

In a further embodiment, an apparatus configured to provide data related to a communication event occurring on a wireless device comprises means for collecting data for a plurality of communication events each respectively corresponding to a wireless device or a network device or both, wherein each communication event further corresponds to a respective location. Further, the apparatus includes means for generating data corresponding to a map representation having a determined area, wherein the determined area corresponds to a geographic area defined by an extent of the respective locations. Also, the apparatus includes means for generating data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation. Additionally, the apparatus includes means for transmitting the generated data corresponding to a map representation and the generated data corresponding to at least one of an individual representation or a combined representation to a requesting computing device for generation of the map representation and at least the one of the individual representation or the combined representation.

In another aspect, a server device configured to provide data related to a communication event occurring on a wireless device comprises a processor and a memory in communication with the processor. The memory is operable to store data for a plurality of communication events each respectively corresponding to a wireless device or a network device or both, wherein each communication event further corresponds to a respective location. Further, the server device includes a download manager stored in the memory and executable by the processor, wherein the download manager is operable to generate data corresponding to a map representation having a determined area corresponding to a geographic area defined by an extent of the respective locations. The download manager module is further operable to generate data corresponding to at least one of an individual representation or a combined representation, wherein each individual representation corresponds to one of the plurality of communication events, and wherein each combined representation corresponds to a combination of at least two of the plurality of communication events if a predetermined overlap would exist between the respective individual representations of the at least two of the plurality of communication events on the map representation. Additionally, the server device includes a communications module operable to transmit the generated data corresponding to a map representation and the generated data corresponding to at least one of an individual representation or a combined representation to a requesting computing device for generation of the map representation and at least the one of the individual representation or the combined representation.

In still another aspect, a method of presenting data related to a communication event occurring on a wireless device comprises receiving data for a plurality of communication events each respectively corresponding to a wireless device or a network device or both, wherein each communication event further corresponds to a respective location. The method further includes generating a map representation having a determined area, wherein the determined area corresponds to a geographic area defined by an extent of the respective locations. Additionally, the method includes generating at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

In a further aspect, at least one processor configured for presenting data related to a communication event occurring on a wireless device comprises a first module for receiving data for a plurality of communication events each respectively corresponding to a wireless device or a network device or both, wherein each communication event further corresponds to a respective location. Further, the at least one processor includes a second module for generating a map representation having a determined area, wherein the determined area corresponds to a geographic area defined by an extent of the respective locations. Additionally, the at least one processor includes a third module for generating at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

In a still further aspect, a computer program product configured for presenting data related to a communication event occurring on a wireless device comprises a computer readable medium comprising instructions. The computer readable medium includes at least one instruction for causing a computer to receive data for a plurality of communication events each respectively corresponding to a wireless device or a network device or both, wherein each communication event further corresponds to a respective location. Further, the computer readable medium includes at least one instruction for causing the computer to generate a map representation having a determined area, wherein the determined area corresponds to a geographic area defined by an extent of the respective locations. Additionally, the computer readable medium includes at least one instruction for causing the computer to generate at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

In another aspect, an apparatus for presenting data related to a communication event occurring on a wireless device comprises means for receiving data for a plurality of communication events each respectively corresponding to a wireless device or a network device or both, wherein each communication event further corresponds to a respective location. Further, the apparatus comprises means for generating a map representation having a determined area, wherein the determined area corresponds to a geographic area defined by an extent of the respective locations. Additionally, the apparatus comprises means for generating at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

In a further aspect, a client device for presenting data related to a communication event occurring on a wireless device comprises a processor and a memory in communication with the processor. Also, the client device includes a retrieval module stored in the memory and executable by the processor. The retrieval module comprises retrieval logic operable to cause the client device to receive data for a plurality of communication events each respectively corresponding to a wireless device or a network device or both, wherein each communication event further corresponds to a respective location. Further, the client device includes a generation manager stored in the memory and executable by the processor. The generation manager comprises generation logic operable to cause the client device to generate a map representation having a determined area that corresponds to a geographic area defined by an extent of the respective locations. The generation logic is further operable to cause the client device to generate at least one of an individual representation or a combined representation on the map representation, wherein each individual representation corresponds to one of the plurality of communication events, and wherein each combined representation corresponds to a combination of at least two of the plurality of communication events if a predetermined overlap would exist between the respective individual representations of the at least two of the plurality of communication events on the map representation.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional components, and in which:

FIG. 1 is a schematic diagram of one aspect of an enhanced presentation system for communication event data;

FIG. 2 is a diagram associated with one aspect of generating first representations of communication event data;

FIG. 3 is a diagram associated with one aspect of combining first representations of communication event data into a second representation;

FIG. 4 is a schematic diagram of one aspect of a computer platform of the computing devices of the system of FIG. 1

FIG. 5 is a schematic diagram of one aspect of components of a communication event in the system of FIG. 1;

FIG. 6 is a schematic diagram of one aspect of components of a communication event request generated in the system of FIG. 1;

FIG. 7 is a schematic diagram of one aspect of components of a retrieval module of the system of FIG. 1;

FIG. 8 is a schematic diagram of one aspect of components of a trickle module of the system of FIG. 1;

FIG. 9 is a schematic diagram of one aspect of components of a user process of the system of FIG. 1;

FIG. 10 is a schematic diagram of one aspect of components of a generation manager of the system of FIG. 1;

FIG. 11 is a diagram of one aspect of a severity threshold table of the system of FIG. 1;

FIG. 12 is a schematic diagram of one aspect of mapping user interface of the system of FIG. 1;

FIG. 13 is a diagram of one aspect of workspace user interface of the system of FIG. 1;

FIG. 14 is a diagram of a different view presented by the workspace user interface of FIG. 12;

FIG. 15 is a diagram of one aspect of a binning grid corresponding to the predetermined area of map representation of the system of FIG. 1;

FIG. 16 is diagram of one aspect of report generated by the system of FIG. 1;

FIG. 17 is diagram of one aspect of report generated by the system of FIG. 1;

FIG. 18 is a flowchart of one aspect of a method of presenting communication event data; and

FIG. 19 is a flowchart of one aspect of a method of providing the communication event data.

### DETAILED DESCRIPTION

The apparatus and methods described herein provide for a computing or monitoring device to present on a map a representation of one or more communication events occurring on a wireless communication network. For example, the communication events may include events such as a call drop, access failure, idle failure, and out of service event corresponding to communications between a wireless device and a network device, such as a base station. As such, the apparatus and methods provide representations that may correspond to a wireless device or a network device, or both, and may include or may be linked to more detailed event-related data. Thus, the present apparatus and methods provide the representations in a manner that makes the events, and their corresponding information, easier to visualize and access on an interactive map.

In one aspect, the presentation may be enhanced by making the representation easier for a user to consume or view. For example, the apparatus and methods described herein operate to combine the representation of two or more communication events if their respective representations overlap on the map by a predetermined amount. The combined communication event representation for the at least two communication events thereby presents the combined communication event data so that the data may be more easily consumed by a user. For example, the combined representation may take up less space on the map than the respective individual representations. Additionally, for example, the combined representation may have one or more characteristics, such as a color or a shape, that provide an indication of the communication event data represented. In one example, which is not to be considered limiting, the combined representations may have a characteristic such as a color that indicates a severity or a count of the number of events, such as call drops, corresponding to the combined representation. Further, for example, the combined representation may include or be linked to a summary or detail of the combined or individual communication event-related data, where this additional information can be easily accessed based on a user input, such as by positioning a pointer over the representation or by inputting a mouse click. Thus, by combining the representations, the present apparatus and methods may make it easier for a user to consume the communication event data.

Additionally or alternatively, in some aspects, the present apparatus and methods may enable combination or representation rules, which define how to combine communication event data or representations, to be configurable by the user. As such, the representation of the combination may be easier for the user to consume if the data are combined in a manner that makes sense to the respective user.

Additionally or alternatively, in some aspects, the present apparatus and methods may include one or more binning rules that enable a quick and easy determination of which ones of a plurality of communication event data should be combined into a single representation. In one case, which is not to be considered limiting, the apparatus and methods determine a minimum area for the map that includes all of the communication event data to be displayed. As such, the geographic area of the map to be generated is dynamic, varying based on the communication event to be represented. Further, the apparatus and methods apply the binning rules to the determined map area, which divides up the determined area into a plurality of bins. As such, the communication event data is analyzed on a bin-by-bin basis in order to determine how to represent the data. In one particular aspect, each bin is sized to be about equal to or slightly larger than a size of the representation to be displayed on the map. As such, any communication events falling within a respective bin are automatically combined and presented in a combined representation. In other words, in this case, the sizing of the bin and the sizing of the representation are determined such that any communication event within any bin has an individual representation that exceeds a predetermined overlap threshold, and thus the event data in each bin is automatically combined without having to determine an overlap amount one-by-one.

Thus, by combining the representations for two or more communication events, or by enabling the combination rules to be configurable by the user, or both, the present apparatus and methods provide enhanced presentation of communication event data.

Further, in another aspect that may be separate from or combined with any of the previous aspects, the presentation of the communication event data may be enhanced by reducing the amount of time to present the communication event data. In one aspect, by combining the representations for two or more communication events into a combined representation, then only a single representation needs to be generated on a map. Thus, the generation of the map may then take less time, thereby enhancing the presentation of the communication event data.

Additionally or alternatively, the presentation may be enhanced by performing the combining of the representations on a second computing device. By combining the representations on a second computing device, the size of the communication event data that needs to be received for presentation by a first communication device may be reduced. Further, receiving such combined data reduces processing time at the device generating the map and the event representations. As such, receiving the combined communication event data may take less time and processing power than it would have taken to receive and process the uncombined communication event data, thereby reducing the wait for a user and enhancing the presentation of the communication event data.

Additionally or alternatively, the presentation may be enhanced by receiving the communication event data, or generating the corresponding representations, or both, in a manner where a user process may continue to service user requests. In one aspect, the computing or monitoring device presenting the representations utilizes a receiving or generating process for a fixed period of time, and then passes control to a user process to check for and allow user activity. Then, for example, after an amount of time, such as a user process idle time, the user process returns control back to the retrieving or generating process. Thus, the user may continue to be serviced by the user process while communication event data is being retrieved or while representations are being generated, or both. Therefore, the presentation and user experience may be enhanced.

Thus, the present apparatus and methods operate to enhance the presentation on a map of representations of communication events by combining representations that overlap by a predetermined amount, and additionally or alternatively by allowing the user to configure how the combination of representations will be represented. Further, additionally or alternatively, the presentation may be enhanced by combining the representations of communication events on a second computing device. In yet another separate or combined option, the presentation may be enhanced by retrieving the communication event data or generating the corresponding representations, or both, in a manner where a user process may continue to service user requests during the retrieval.

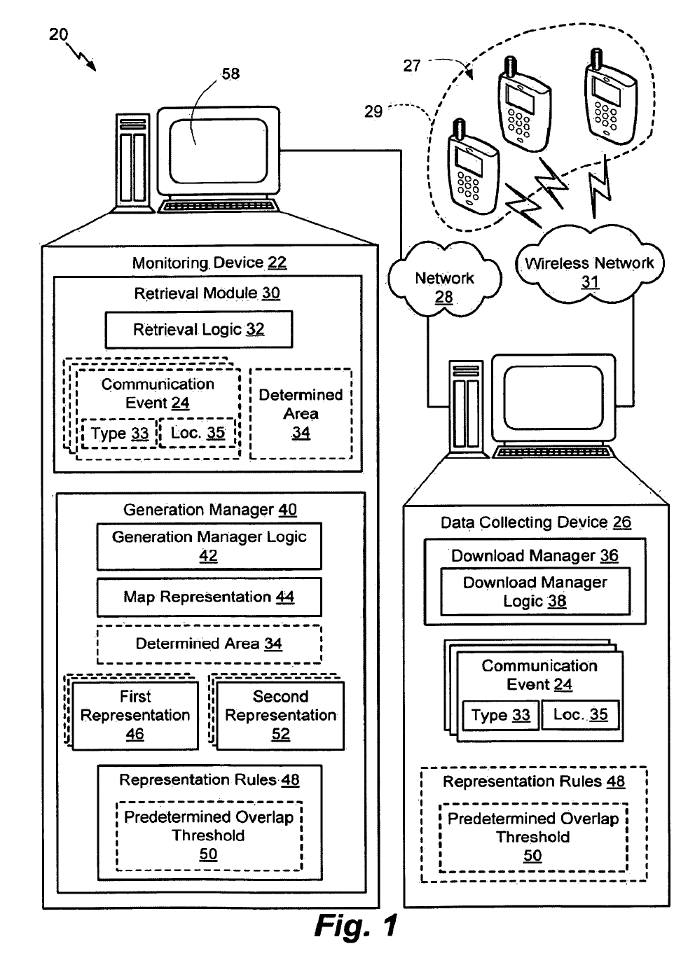

Referring to FIG. 1, aspects of an enhanced presentation system 20 comprise a monitoring device 22 operable to receive one or more communication events 24 from a data collecting device 26 located across a communications network 28. For example, each communication event 24 may be collected from or may correspond to one or more wireless devices 27, or may correspond to one or more network devices such as a base station, or may correspond to both, operating within one or more geographic areas or cells 29 respectively serviced by one or more wireless networks 31. In some aspects, communication events 24 may include a type 33 and a location 35. The type 33 may refer to the type of event, such as an access failure, an access success, a call drop, an idle failure, an out of service event, or any other event relating to the operation of the respective wireless device on the respective wireless network. The location 35 may refer to data identifying or associated with a geographic area, such as longitude or latitude, or network location, such as a base station identifier, at which the respective communication event occurred. The monitoring device 22 may further include a retrieval module 30 with retrieval logic 32 for retrieving the communications event 24 from the data collecting device 26. The retrieved communication events 24 correspond to a geographic area 34. In one aspect, determined area 34 may be determined based on the extent of the respective locations 35 associated with the retrieved communications events 24, and in some aspects further based on the size of the representations. In other aspects, for example, determined area 34 may be defined by a user. In this case, for example, communication events 24 having a location 35 within determined area 34 are retrieved. In any case, retrieval module 30 may send a request for communication events 24 to data collecting device 26, which may include a download manager 36 with download manager logic 38 for collecting and sending the corresponding communication event data 24 to the monitoring device 22.

Monitoring device 22 may further include a generation manager 40 with generation manager logic 42 for generating a map representation 44 that includes representations of the retrieved communication events 24 for determined area 34. In particular, generation manager 40 may be further operable to associate a first representation 46 to each of the communication events 24 based on representation rules 48. For example, because the number of communication events 24 may be large compared to a size of a display 58 of monitoring device 22, it may be difficult for a user to consume map representation 44 as there may be many representations that interfere with one another. In an example case, if there were one thousand communication events 24, then depending on the size of the display and the size of each representation, it may be difficult to present all of the events on the display 58 of the monitoring device 22 without overlapping the first representations 46 associated with each of the communication events 24. As such, the generation and presentation of overlapping representations may make it difficult for a user to distinguish between the respective first representations 46. Additionally, in this case, it may be time consuming to generate the one thousand first representations 46 on the map representation 44.

As such, generation manager 40 may be operable to combine the first representation 46 of two or more communication events 24 whose respective first representations 46 have an overlap exceeding a predetermined overlap threshold 50 to generate a second representation 52 that represents the combined communication event data 24. For example, predetermined overlap threshold 50 may define a maximum acceptable amount of overlap, and any two or more representations exceeding the maximum are combined to form second representation 52, which is displayed instead of the respective first representations 46.

Additionally, it should be noted that first representation 46 and second representation 52 may include, but are not limited to, an icon or a graphical image corresponding to the respective individual or combined event. Further, it should be noted that first representation 46 and second representation 52 may represent a wireless device, or a network device such as a base station, or both. Also, it should be noted that first representation 46 and second representation 52 may represent, correspond to, or otherwise may be linked to data relating to one or more communication events 24.

Further, the generation manager 40 is operable to generate a map representation 44 for the determined area 34, and to generate one or more of the first representations 46, or one more of the second representations 52, or some combination of both, on the map representation 44. For example, the respective location 35 may determine where on the map representation 44 each first representation 46 is positioned. Thus, map representation 44 may be presented on the display 58 of the monitoring device 22 for consumption by a user.

Therefore, the described aspects are operable to combine representations for communication event data 24, thereby enhancing an ability of a user to view the representations, and optionally reducing the time taken by generation manager 40 to generate the map representation 44 with the communication event representations 46 and/or 52 on the display 58 of the monitoring device 22.

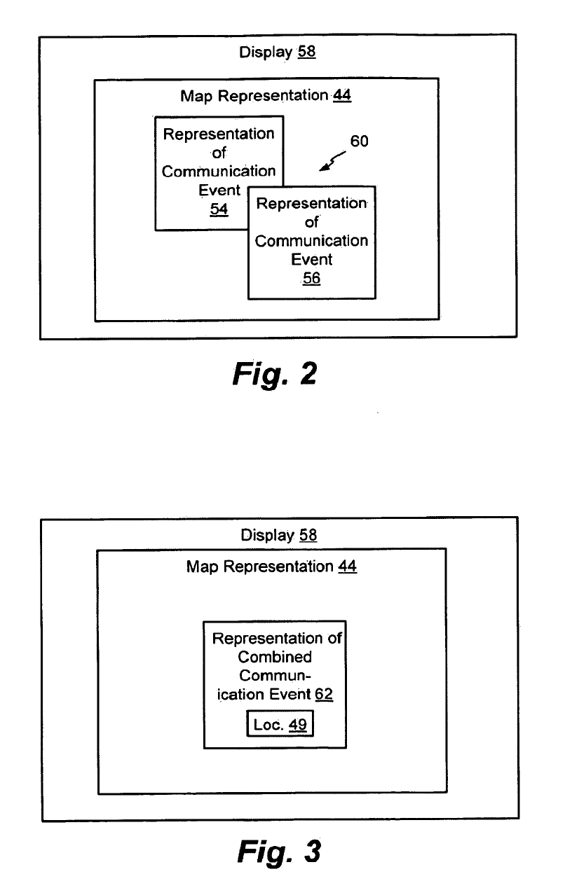

Further, referring to FIGS. 2 and 3, in one non-limiting case of combining representations, for example, a representation of a communication event 54 and a representation of a communication event 56 are examined by the generation manager 40 to determine if the two representations 54 and 56 have an overlap within or exceeding predetermined overlap threshold 50 on the map representation 44 when generated on the display 58 of the monitoring device 22. In this case, representations 54 and 56 may correspond to any communication events 24. Further, it should be noted that while the example refers to two representations, the present apparatus and methods include performing this process on any number of representations. Representations 54 and 56 comprise examples of first representation 46 described above. The overlap 60 of the representation of communication event 54 and the representation of communication event 56 is determined based on the size of the respective representations and based on the relative locations 35 of each event 54 and 56 on map 44. Additionally or alternatively, overlap 60 may be further determined based on a scale of the map representation 44. Additionally or alternatively, overlap 60 may be further determined based on a size of the display 58. The overlap 60 is then compared with the predetermined overlap threshold 50 and, if applicable, the representation of communication event 54 and the representation of communication event data 56 are combined into a combined communication event representation 62 according to the representation rules 48. It should be noted that combined communication event representation 62 is an example of second representation 52 described above. Further, for example, in some aspects the location 49 of the combined communication event representation 62 may be based on a predetermined formula, such as an average, that takes into account the respective locations 35 of the representation of communication event 54 and the representation of communication event 56. Further, as noted above, the representation rules 48 may be user defined.

It should be noted that each representation of one or of some combination of communication event data may include a plurality of data corresponding to the respective one or the respective combination of communication events. As such, each individual or combined representation on the map may include or may correspond to additional event-related data. For example, the representation itself may have one or more characteristics that reflect some portion of the event-related data. In one case, an icon used in the representation may have a particular shape, color or other characteristic that provides such an indication. Further, the representation may be interactive, such that holding a pointer over the representation or clicking on the representation causes the generation of some form of the event-related data. For example, in one aspect, holding a pointer over the representation may cause a pop-up table of summary data corresponding to the representation. In another aspect, for example, clicking on the representation may cause generation of a pop-up table having details of the corresponding event-related data. Since each representation may correspond to either one or more wireless devices and one or more communication event data occurring thereon, or one or more network devices (such as a base station in a CDMA system) and one or more communication event data associated therewith, the present apparatus and methods utilizes these features to make it easy to comprehend communication events on a map, as well as making it easier to access a summary or the details corresponding to such events for either wireless devices or network devices.

Thus, by combining the representation and event-related data of overlapping communication events, such as the first representation of communication event 54 and the first representation of communication event 56, the present apparatus and methods provide for easier viewing of map representation 44 and the associated communication event-related data.

Thus, system 20 provides apparatus and methods for enhancing the presentation of communication event 24 by combining communication events 24 that have an overlap 60 exceeding a predetermined overlap threshold 50 on the map representation 44. Alternatively or additionally, in other aspects, the apparatus and methods enable a user to select how the combined presentation of the communication event 24 is represented. Therefore, system 20 adds value to the user experience in presenting communication event data 24 on a map representation 44 by reducing the number of representations that need to be generated on the map representation 44, and optionally reducing the amount of time to generate the map representation 44. Additionally or alternatively, the apparatus and methods reduce the number of representations sent by or received from data collecting device 26, thereby reducing the amount of time necessary for monitoring device 22 to receive the data and thus enhancing the user experience.

According to some aspects, monitoring device 22 and data collecting device 26 may comprise any type of computerized, communication device. For example, as illustrated in FIG. 1, monitoring device 22 and data collecting device 26 may comprise a fixed communication device, such as a network device, a server, a computer workstation, etc. In one aspect, for example, monitoring device 22 may be a desktop, laptop or work station computer, which communicates across a network, such as the Internet, with data collecting device 26 such as a server. Further, it should be understood that devices 22 and/or 26 are not limited to the illustrated devices, but may further include a Personal Digital Assistant (PDA), a two-way text pager, a portable computer having a wired or wireless communication portal, a mobile communication device, such as a wireless and/or cellular telephone, and any type of computer platform having a wired and/or wireless communications portal. Further, data collecting device 26 can be a remote-slave or other similar device, such as a remote sensor, a remote server, a diagnostic tool, a data relays, and the like, which does not have an end-user thereof, but which simply communicates data across a wireless or wired network. In alternate aspects, monitoring device 22 and/or data collecting device 26 may be a wired communication device, such as a landline telephone, personal computer, set-top box or the like. Additionally, it should be noted that any combination of any number of monitoring device 22 and/or data collecting device 26 may be utilized in system 20. Therefore, the present apparatus and methods can accordingly be performed on any form of wired or wireless device or computer module, including a wired or wireless communication portal, including without limitation, wireless modems, PCMCIA cards, access terminals, personal computers, telephones, or any combination or sub-combination thereof.

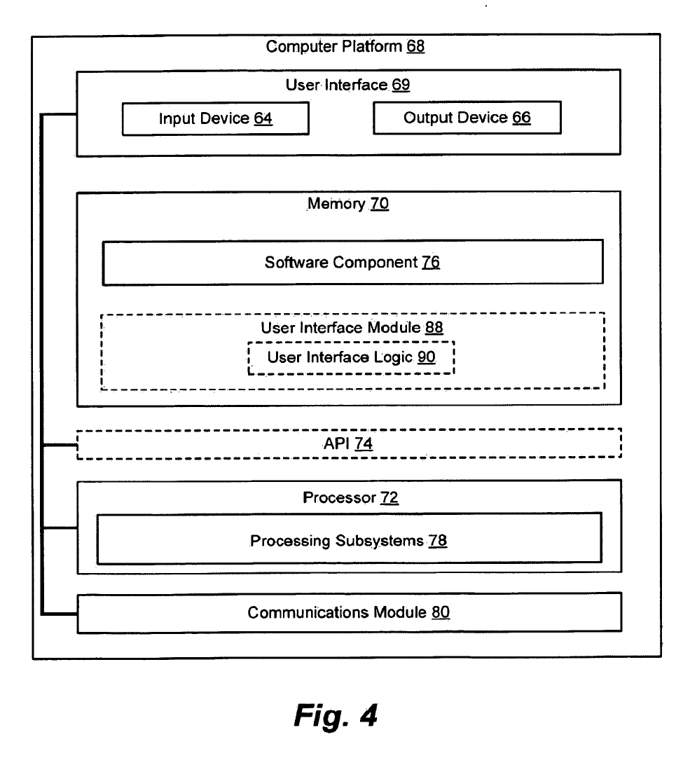

Additionally, referring to FIG. 4, monitoring device 22 and/or data collecting device 26 may include a computer platform 68 having communicatively coupled components such as a user interface 69, a memory 70, a processor 72 and a communications module 80 that allows communication between the components as well as between the respective device and a communication network.

User interface 69 may include an input device 64 operable to generate or receive an input into the respective computing device, and an output device 66 operable to generate and/or present information for consumption by a user of the respective computing device. For example, input device 64 may include one or more of a keypad, keyboard, a mouse, a touch-screen display, a stylus, or a microphone in association with a voice recognition module, etc. In certain aspects, input device 64 may provide for user input of requests for generating the map representation 44 (FIG. 1.) Further, for example, output device 56 may include one or more of a display, such as display 58 (FIGS. 2 and 3), an audio speaker, a light generator, or a haptic feedback mechanism, etc. Output device 56 may generate a graphical user interface, a sound, a light, a feeling such as a vibration, etc., and such outputs may be associated, for example, with the presentation of representations of one or more communication events 24 on a map 44.

Further, computer platform 68 is operable to execute applications to provide functionality to the respective computing device. Computer platform 68 may include memory 70, which may comprise volatile and nonvolatile memory portions, such as read-only and/or random-access memory (RAM and ROM), erasable programmable read-only memory (EPROM), electrically erasable programmable read-only memory (EEPROM), flash memory, and/or any other type of memory operable on a computer platform. Further, memory 70 may include active memory and storage memory, including an electronic file system and any secondary and/or tertiary storage device, such as magnetic media, optical media, tape, soft and/or hard disk, and removable memory components.

Further, computer platform 68 may also include processor 72, which may be an application-specific integrated circuit (ASIC), or other chipset, processor, logic circuit, or other data processing device. In some aspects, such as when data collecting device 26 comprises a cellular telephone, processor 72 may execute an application programming interface (API) layer 74 that interfaces with any resident software components 76, such as a voice call module, a data call module, a media-related application, retrieval module 30, generation manager 40, download manager 36, etc., in memory 70. API 74 may be a runtime environment executing on the respective communication device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Additionally, in some aspects, processor 72 may include various processing subsystems 78 embodied in hardware, firmware, software, and combinations thereof, that enable the functionality of data collecting device 26 or monitoring device 22, and that enable the operability of the respective device on communications network 28 (FIG. 1). For example, processing subsystems 78 allow for initiating and maintaining communications, and exchanging data, with other networked devices as well as within and/or among components of the respective computing device. In one aspect, such as in a cellular telephone, processor 72 may include one or a combination of processing subsystems 78, such as: sound, non-volatile memory, file system, transmit, receive, searcher, layer 1, layer 2, layer 3, main control, remote procedure, handset, power management, diagnostic, digital signal processor, vocoder, messaging, call manager, Bluetooth® system, Bluetooth® LPOS, position determination, position engine, user interface, sleep, data services, security, authentication, USIM/SIM (universal subscriber identity module/subscriber identity module), voice services, graphics, USB (universal serial bus), multimedia such as MPEG (Moving Picture Experts Group) protocol multimedia, GPRS (General Packet Radio Service), short message service (SMS), short voice service (SVS™), web browser, etc.

Computer platform 68 may further include communications module 80 that enables communications among the various components of the respective computing device, as well as being operable to exchange communication events 24 between the respective computing device and communications network 28 (FIG. 1). Communications module 80 may be embodied in hardware, firmware, software and/or combinations thereof, and may further include all protocols for use in intra-device and inter-device communications. Further, communications module 80 is operable to transmit and/or receive information, such as data for communication events 24, in accordance with the apparatus and methods described herein.

Additionally, in both monitoring device 22 and data collecting device 26, referring to FIGS. 1, 4 and 5, memory 70 may be operable to store all or at least a portion of one or more communication events 24. Each communication event 24 may be based on any type of call or communication exchange, including, but not limited to, one or any combination of a voice call, a data call, a limited capacity call having a maximum allowable payload such as a short message service (SMS) call or text message and/or a short voice service (SVS™) call or voice message, or a multimedia message. Further, communication event 24 may be based on any type of communication protocol and/or technology. In some aspects, communication event 24 may be associated with wireless communication where wireless device 27 (FIG. 1) communicates with wireless network 31, such as via a base station. As such, the communication event 24 may be associated with a wireless device operating on a network, such as a cellular phone, as well as with a network device, such as a base station.

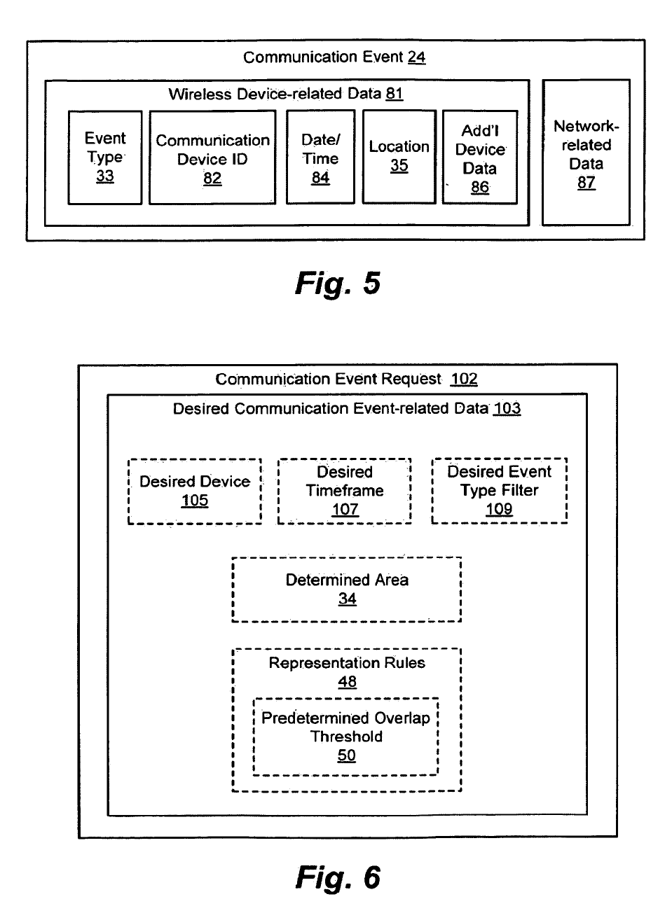

Referring specifically to FIG. 5, in some aspects, communication event 24 may include or may correspond to, but is not limited to, one or more event-related data, such as wireless device-related data 81 and network-related data 87. Wireless device-related data 81 includes data associated with the respective wireless device that experienced the respective communication event. For example, wireless device-related data 81 may include, but is not limited to, one or more data such an event type 33, a communication device identification (ID) 82, a date/time 84, a location 35, or additional device-related data 86. It should be noted, however, that the communication event 24 may include other data associated with the respective communication protocol.

In one embodiment, for example, event type 33 may include, but is not limited to, one or more data representing an event such as an access failure, an access success, a call drop, an idle failure, an out of service event, or a multiple error code, e.g. a code indicating that more than one of the prior events have occurred. In other words, event type 33 represents the what event occurred on or to the wireless device.

Communication device ID 82 may include any type of data to identify the wireless device 27 (FIG. 1) associated with the communication event 24 or from which the communication event 24 was collected. For example, communication device ID 82 may include, but is not limited to, one or more of data such as a cellular telephone number, a mobile directory number (MDN), an electronic serial number (ESN), a mobile equipment identifier (MEID), an international mobile equipment identity (IMEID), an international mobile subscriber identity (IMSI), a temporary mobile subscriber identity (TMSI), or a mobile subscriber identification number (MSIN).

Date/time 84 may include any type of data to identify a date, a time, or both, associated with the communication event 24. In one embodiment, the date/time 84 may include the date and time when the communication event 24 occurred, such as may be obtained from a timestamp generated by the wireless device or by the wireless network.

Location 35 may include any type of data to corresponding to one or more of a geographic point or area, or a network location, associated with communication event 24. In one embodiment, the location 35 may include a latitude and longitude for where the communication event 24 occurred, for example, obtained from one or some combination of a satellite-based or terrestrial-based position determination system. Further, location 35 may be a name of a geographic area or region, or an identifier of a network component communicating with wireless device 27 (FIG. 1) that can be used to determine a geographic or network area.

Additional device data 86 may include any type of data relating to one or more properties of the respective wireless device. For example, additional device data 86 may include, but is not limited to, one or more of data such as a hardware configuration, a software configuration, a firmware configuration, provisioning information, device component characteristics, device model number, device make, network operator identifier, customer number, or device user profile information.

Network-related data 87 may include any data associated with a wireless network or a wireless network component corresponding to the respective communication event or the respective wireless device, or both. For example, network-related data 87 may include, but is not limited to, one or more data such as a network identifier, a network operator identifier, a network component identifier, such as a base station number, a cell identifier, or a pseudo-random number (PN). In one case, network-related data 87 may be the identifier of the base station and/or the cell with which the cellular telephone was communicating at the time the communication event 24 occurred.

Additionally, should be understood that communication event 24 may represent an aggregate communication event 24 and/or a series of communication events 24.

Referring back to FIG. 4, in some aspects, memory 70 may further include user interface module 88, which is executable by processor 72 to allow the device user to interface with any hardware, firmware or software components generating a user output and/or requiring a user input on the respective computing device 22 or 26. User interface module 88 may comprise one or any combination of hardware, software, firmware, data or executable instructions operable to perform these functions. For example, in some aspects, user interface module 88 on monitoring device 22 may comprise user interface logic 90 operable to interface between output device 66 and generation manager 40 and/or any of the plurality of software components 76 in order to present outputs, such as a graphical menu, a sound, map representation 44 (FIG. 1), etc., and in order to prompt the user to enter inputs, such as rules 48 for combining and representing communication events 24, which communication events 24 to collect, user input for more information on a representation, etc. Further, for example, in generation of map representation 44, user interface module 88 may operate to provide the user with a menu or list of the plurality of communication event types 33 (FIG. 5) to allow the user to define or filter which communication events 24 to present. Further, the user interface module 88 may detect conditions from the input device 64, such as when the pointer is positioned over a representation of a communication event for a predetermined amount of time, which may trigger the user interface module 88 to present additional information regarding the respective communication event, where the additional information is generated by the generation manger 40 for presentation by the user interface module 88 on output device 66, such as a display.

Further, in both monitoring device 22 and data collecting device 26, memory 70 is operable to include device-specific applications, and/or software components, and/or modules. In particular, the memory of data collecting device 26 may store download manager 36, while the memory of monitoring device 22 may store retrieval module 30 and generation manager 40.

For example, referring to FIG. 1, download manager 36 may comprise one or any combination of hardware, software, firmware, data and executable instructions operable to download communication events 24 from data collecting device 26 to monitoring device 22, for example, in response to a request. As noted above, download manager 36 may include download manager logic 38 for gathering and sending the communication event data 24 to the monitoring device 22. In one aspect, download manager 36 is operable to collect one or more communication events 24 that are already resident in memory 70 of data collecting device 26. In this case, for example, data collecting device 26 may have previously received communication event data 24 from one or more wireless devices 27, or from another computing device operating to collect this data from the wireless devices. In other aspects, download manager 36 is operable to act on user requests for communication event data 24, and as such download manager 36 may be operable to send a collection request to one or more wireless devices 27 to obtain one or more communication events 24. In one aspect, download manager 36 is operable to download one or more communication events 24 in response to a communication event request 102 (FIG. 6) received from monitoring device 22, which will be discussed in more detail below.

In addition or in the alternative, data collecting device 26 may process all or some portion of the communication events or the respective representations, or both, prior to downloading the data to monitoring device 22. In some aspects, for example, download manager 36 or download manager logic 38 may include the functionality to determine overlaps in representations of communication events 24 and pre-combine the corresponding communications events prior to send this data to monitoring device 22. In this case, for example, download manager 36 or download manager logic 38 may include or may have access to representation rules 48. Further, in this case, download manager 36 or download manager logic 38 may be operable to perform one or more binning rules 91 (FIG. 9) as described herein. In such aspects, for example, data collecting device 26 may further comprise all or some portion of the components of generation manager 40. In this aspect, the download manager 36 may trigger execution the resident generation manager 40 or the respective components thereof located on data collecting device 26 to satisfy a received communication event request 102.

Thus, the download module 36 is operable to download the respective data or representations corresponding to one or more requests for communication events 24

In one optional aspect, which may be combined with any of the above-noted aspects, download manager 36 is operable to download the requested communication events 24 and/or the corresponding representations in a “trickle” fashion. The term “trickle” refers to a process in which the download manager 36 separately downloads at different times a respective portion of the requested communication events 24 and/or the corresponding representations. For example, each portion may be sized or have a time limit based on a data size limit, a throughput time limit, a throughput capacity limit, a monitoring device user activity level or a direct user request such as a suspension request. The download manager 36 is operable to continue downloading the remaining portions of the requested communication events 24 and/or the corresponding representations based on one or more resume factor, such as a predetermined time limit, a predetermined available throughput capacity, a monitoring device user activity level or a direct user request such as a request to continue downloading. In this manner, the download manager 36 cooperates with retrieval module 30 to download the requested communication events 24 and/or the corresponding representations a portion at a time in a “trickle” fashion. Such a “trickle” method may enhance the experience of the user of monitoring device 22 by not tying up processing resources and/or data throughput channels. Additional aspects of the “trickle” downloading are described below with respect to trickle module 97 (FIG. 8).

Thus, the download manager 36 is operable to download the communication events 24 and/or the corresponding representations to a requesting communications device, such as monitoring device 22. In particular, in an aspect, the download manager 36 is operable to respond to a communication event request 102 and download the requested communication events 24 and/or the representation of the communication events 24 to satisfy the communication event request 102. Further, in an aspect, download manager 36 is operable to pre-process the requested communication events based on representation rules 48, and optionally including one or more binning rules, which allow the download manager to combine communication event data.

Additionally, referring to FIGS. 1, 6 and 7, retrieval module 30 may comprise one or any combination of hardware, software, firmware, data and executable instructions operable to retrieve communication events 24 from data collecting device 26. In an aspect, retrieval module 30 is operable to generate communication event request 102 (FIG. 6) to retrieve communication events 24 of interest to the user of monitoring device 22.

Referring specifically to FIG. 6, communication event request 102 defines one or any combination of aspects relating to communication events 24 desired to be viewed by a user of monitoring device 22. As such, communication event request 102 may include one or more desired communication-event related data 103, which relates to one or more of the data of wireless device-related data 81 (FIG. 5) or network-related data 87 (FIG. 5), or both, as defined by communication event 24 (FIG. 5). Depending on the specific application of the present apparatus and methods, communication event request 102 may take many different forms. For example, in one case that is not to be considered limiting, desired communication event-related data 103 includes one or more desired device identifiers 105, one or more desired timeframe identifiers 107, and one or more desired event type filters 109. Desired device identifiers 105 may include, but are not limited to, one or more data corresponding to one or more communication device IDs 82 such as an MDN, additional device data 86, or network-related data 87 such as a base station ID. Desired timeframe identifiers 107 may include, but are not limited to, one or more data such as a date, a time, a range or ranges of dates or times or both, etc., of interest. Further, desired event type filters 109 may include, but are not limited to, one or more data corresponding to event types 35. As such, in one example of this case, communication event request 102 allows a user of monitoring device 22, such as a network operator, to request particular event-related dated for a particular population of wireless devices over a particular timeframe. In other cases, for example, communication event request 102 may include determined area 34 specified by a user, for example, when events occurring in a specific geographic or network-based area are of interest to the user. In yet other cases, for example, communication event request 102 may include representation rules 48, including the predetermined overlap threshold 50 or binning rules 91 desired by the user, which may trigger the data collecting device 26 or another device to combine data or generate representations prior to sending the data to monitoring device 22. In other words, the communication event request 102 may include any information for data collecting device 26 to determine which ones of the plurality of communication events 24 or their associated data to collect, or in what form to provide the collected data to the monitoring device 22.

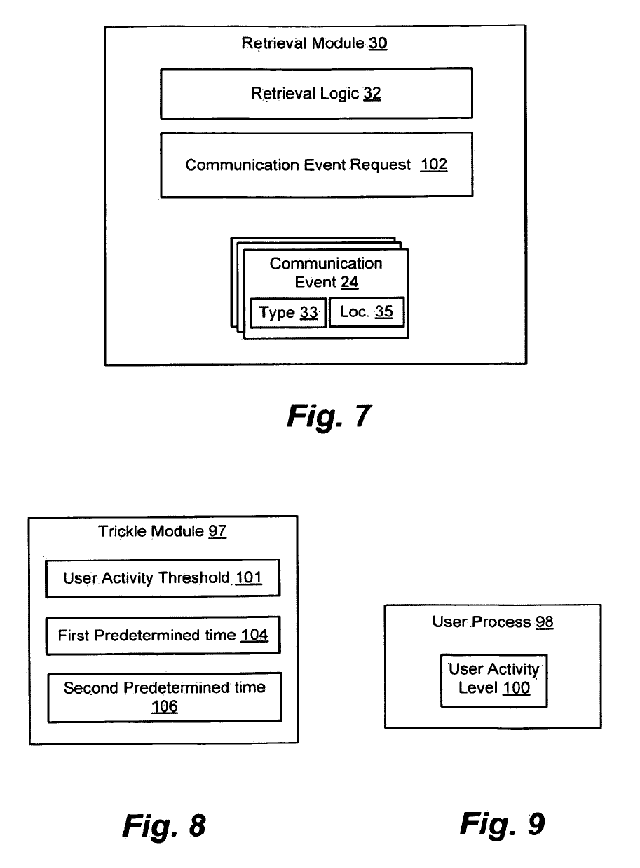

Referring to FIGS. 7, 8 and 9, in one optional aspect, which may be combined with any of the above-noted aspects, retrieval module 30 may be operable to retrieve the communication events 24 in a “trickle” fashion, which comprises a moderated or throttled download processing depending on user activity. For example in an aspect, the retrieval module 30 may further include or have access to a trickle module 97, which is operable to interact with a user process 98 stored in memory 70 of monitoring device 22. User process 98 may be any process executable by the processor 72. User process 98 includes a user activity level 100 that defines an amount or the presence of user interactivity with the monitoring device 22. Further, user activity level 100 may be an instantaneous measure or a measure over a time period. In any case, user activity level 100 reflects how active a user is in using the input device 64 or the output device 66. For example, user activity level 100 may indicate a number of user inputs at a keyboard or mouse of monitoring device 22, which may be a high value depending on the number or which may be low value if no inputs are being received or if a predetermined threshold of inputs/time has not been met.

Further, in an aspect, trickle module 97 defines a user activity threshold 101 and one or more time periods that provide for downloading data corresponding to communication events 24 in the above-noted “trickle” fashion. For example, retrieval module 30 retrieves a portion of the requested communication events 24 for a first predetermined time 104 and then checks if the user activity level 100 of the user process 98 exceeds the predetermined user activity threshold 101. If the user activity level 100 exceeds the threshold 101, then the retrieval module 30 switches control to the user process 98 and allows user activity to occur while suspending further downloading. In this way, the retrieval module 30 increases the likelihood that the user process 98 may service the activity of the user. The user process 98 then executes, and the trickle module 97 waits until the user process 98 is in an idle state for a second predetermined time 106, after which the trickle module 97 switches the control back to the retrieval module 30 to continue with downloading the data. Additionally, for example, trickle module 97 may implement any aspects of “trickling” discussed above with respect to download manager 36 (FIG. 1). Thus, in this example, trickle module 97 manages downloading of requested communication events 24 and/or corresponding representations based on the user activity level 100.

Thus the retrieval module 30 is operable to generate a communication event request 102 and retrieve the requested communication events 24 and/or representations from another communications device, such as data collecting device 26.

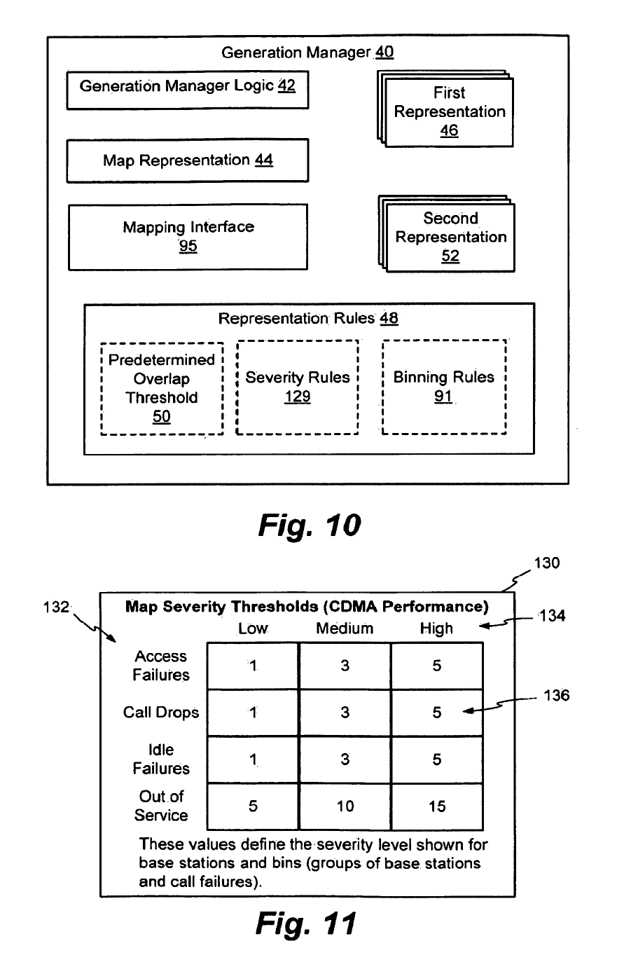

Additionally, with respect to monitoring device 22, referring to FIGS. 1 and 10, generation manager 40 may be stored in and executed from memory 70. Generation manager 40 may comprise one or any combination of hardware, software, firmware, data or executable instructions operable to generate the map representation 44. Further, it should be understood that generation manager 40 may, alternatively or in addition, reside on another computing device in communication with monitoring device 22. For example, all or some portion of generation manager 40 may reside on a server such as data collecting device 26, and the presentation may occur on a client device such as monitoring device 22.

In an aspect, generation manager 40 comprises generation manager logic 42 operable to generate a map representation 44 for the determined area 34 and to generate a representation for the requested communication events 24 on the map representation 44. In particular, the representations of the requested communication events 24 may be based on representation rules 48, which define how to represent one or a combination of communication events 24. The representation rules 48 can be represented with a general purpose programming language. Further, the representation rules 48 may be static or may be dynamic, or some combination thereof. For example, representation rules 48 may define particular colors or icons, or both, corresponding to different communication events 24 based on their type 33, location 35, or based on other data corresponding to the communication event 24, or any combination thereof. Each defined color, icon, or both, may define the first representation 46 of the individual communication event, as discussed above. Further, representation rules 48 may define when to combine one or more communication events 24 into a single representation, as opposed to separate individual representations. For example, representation rules 48 may be based on whether an overlap 60 (FIG. 2) between two or more individual representations exceed a predetermined overlap threshold 50. The generation manager 40 may then associate a second representation 52 for the combined communication events 24, wherein the color, icon, or both, may be different from first representation 46 in order to distinguish between the representations. Additionally, the representation of the communication events 24, such as representation 46 and/or 52, may further include text describing the respective event or the other details corresponding to the respective communication event 24. Since the respective representation of an individual or a combined communication event, or of an individual or combined wireless device or network device, may vary depending on the corresponding data, generation manager 40 may in effect have the ability to generate one of a plurality of representations for each individual or combined representation.

Additionally, representation rules 48 may include one or more severity rules 129 to enable graphically distinguishing representations of combined communication events. Referring to FIG. 11, in one non-limiting case, generation manager 40 is operable to present a user with a table 130 with user determinable fields that establish severity rules 129 for how to represent a severity of grouped events. For example, in the illustrated case, a base station may be associated with many communication events 24, and column 132 represents the different types 33 of communication events 24. Further, one or more severity levels may be established for each type of event, in this case the top row 134 represents three severity levels: Low, Medium, or High. For example, each severity level 134, such as Low, Medium, and High, may be associated with a unique color for the icon to use to represent the base station and the events occurring associated therewith, e.g. Low=Green, Medium=Yellow, and High=Red. Additionally, for each severity level 134, table 130 may include a user-definable severity threshold 136, such as a field into which the user may enter a desired number. So, for example the number 5 (five) is in the row for “idle failures” and in the column for “High,” so if there are 5 (five) or more “idle failures” associated with a base station then the representation for the base station should be “High” and indicated as such with the color red. In other words, one or more severity thresholds enable generating at least one of the first representation and the second representation based on counting a number of event types associated with each of the first representations or each of the second representations, then comparing the count to a corresponding severity threshold value, and generating a predetermined one of a plurality of first representations and second representations depending on whether the count exceeds the severity threshold value. In particular, generating a predetermined one of a plurality of first representations and second representations further comprises generating the respective representation with one of a plurality of severity indicator characteristics, such as different colors or different icons, based on the comparison. As such, the different representation of different severity levels enable a user to quickly examine the number of errors associated with a base station on map representation 44. So, for example, if there are many base stations on map representation 44, and the user wants to locate any base station that had many errors, e.g. over a predetermined severity threshold, then the user could scan for red icons and then retrieve more information for the base stations that are red.

As noted previously, representation rules 48 may further specify how to combine the representation of two or more communication events 24. In one non-limiting example, first representation 46 and second representation 52 may be representations of base stations and events corresponding to the respective base stations. In this case, representation rules 48 may further define how to combine representations of two or more overlapping representations of base stations, where the severity thresholds 136 for the events of each base station are taken into consideration in determining how to represent the newly combined base station data. For example, representation rules 48 may define that the combined base station representation includes the highest severity level of any of the base station representations in the combination. In this case, if two base stations representations are combined, and one has a low severity level and the other a high severity for a respective communication event, then the combined base station representation will be presented as having the high severity level. It should be noted that the combined representation may have a severity level indicator (e.g. color) corresponding to a severity level of a single communication event type for one of the representations in the combination, or for any combination of communication event types for the representations in the combination. In other words, if communication event data comprising call drops for two different base stations are represented in a combined base station icon, then the corresponding combined base station icon may have a severity level indicator set to the highest severity level for call drops of either of the two base stations. In another example, if communication event data comprising call drops and idle failures for two different base stations are represented in a combined base station icon, and if the call drop severity level is low and the idle failure severity level is high, then the corresponding combined base station icon may have a severity level indicator set to reflect the high severity level. As such, this manner of combining representations may enable the user to quickly identify base station combinations that have a high number of errors associated with them.

Thus, the representation rules 48 provide a flexible and convenient mechanism for a user to specify how communication events 24 should be represented and how communication events 24 should be combined.

Further, referring back to FIG. 10, generation manager 40 may optionally include a mapping interface 95 to control how to generate map representation 44. For example, mapping interface 95 may be used to select what communication events are represented and how to represent them, such as when sorting through the collected communication events 24 associated with more than one communication event request 102 (FIGS. 6 and 7) is desired, or when further filtering the data from a single communication event request is desired. Additionally, the mapping interface 95 allows a user to control the geographic area illustrated in the map representation 44. The mapping interface 95 can include fixed or dynamic parameters, or some combination thereof, and mapping interface 95 can be represented with a general purpose programming language.

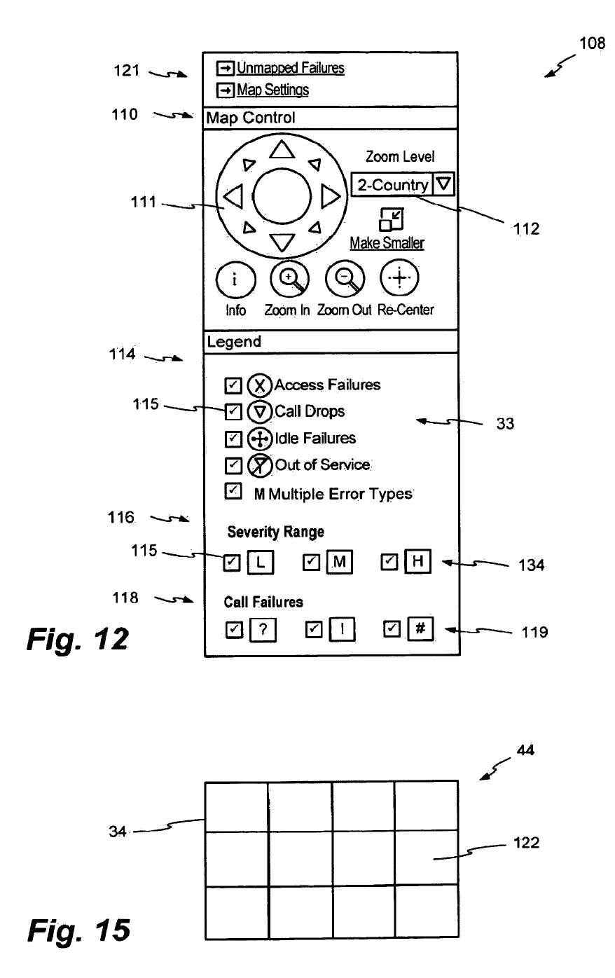

For example, in one non-limiting case, referring to FIG. 12, generation manager 40 may be operable to generate and present to user a user interface 108 that defines mapping interface 95. User interface 108 enables the user to define one or more variables associated with the generation of map representation 44 and the representation of the requested communication events 24.

In an aspect, user interface 108 may include one or more map controls 110 operable to change the geographic area illustrated in map representation 44. For example, map controls 110 may include one or more of a zoom level, a directional control, and/or feature controls to change the geographic area of the map or the appearance of the map or the appearance of features, such as roads, cities, etc. on the map.

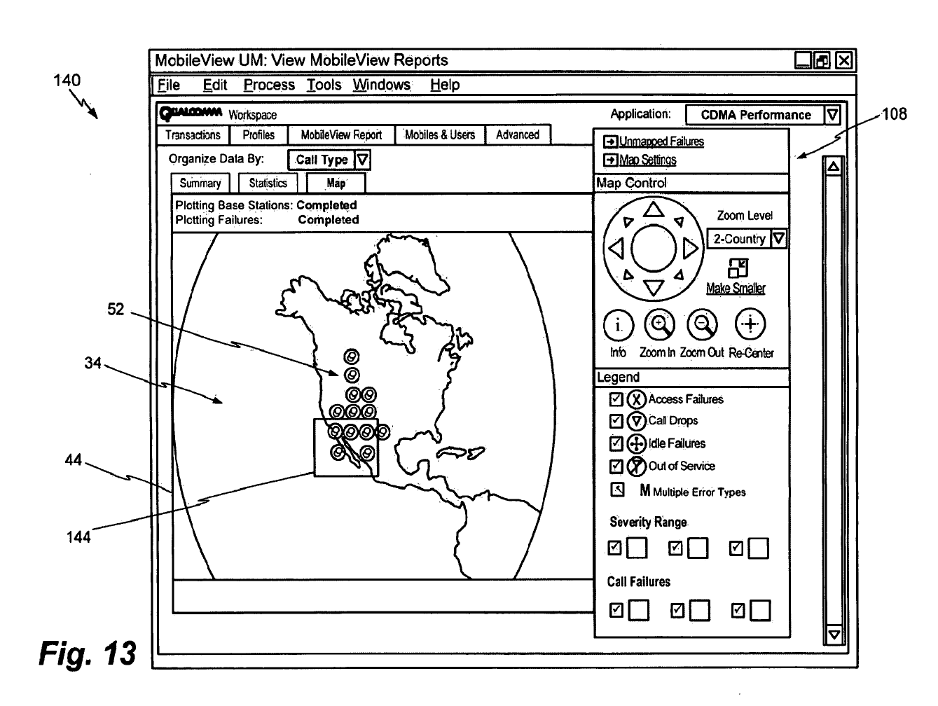

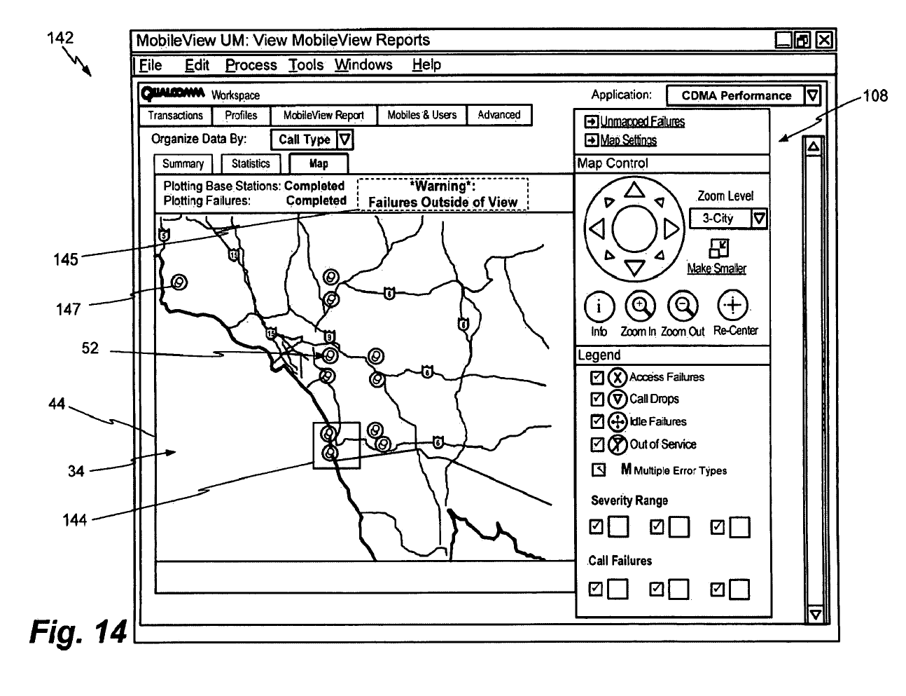

In one non-limiting case, additionally referring to FIGS. 13 and 14, the determined area 34 may be changed by either clicking on the direction arrows 111 or by changing the level of zoom 112. In one embodiment, both options 111, 112 are presented to the user by the user interface module 88 (FIG. 4). The generation manager 40 may respond to changes in the determined area 34, based on user input into user interface 108, by generating a new map representation 44 and new representation for the communication events 24. As such, in an example of one case, FIG. 13 corresponds to a map representation 44 associated with a first zoom level, such as a level having a value of 2, corresponding to a country-sized zoom. Similarly, FIG. 14 corresponds to a map representation 44 associated with a second zoom level, such as a level having a value of 3, corresponding to a city-sized zoom. Thus, one or more map controls 110 enable the user to alter the selection of the determined area 34 and the representation of the communication events 24.

Further, in another aspect, user interface 108 may include one or more communication event type controls 114 operable to change the type of communication events 24 illustrated on map representation 44. For example, in one case not intended to be limiting, the type of communication events 24 may correspond to type 33, including but not limited to an access failure, a call drop, an idle failure, an out of service event, and a multiple error indicator, which represents multiple events. In one case, communication event type controls 114 dictate which communications event types will be associated with a representation of both a wireless device and a base station on map 44. Each communication event type control 114 may correspond to a selection indicator 115, which determines if the respective event type is selected or de-selected from inclusion in map representation. For example, selection indicator 115 may include, but is not limited to, inputting or removing a check from a checkbox. As such, in an example of this case, un-checking “Call Drops” will filter out all call drops which includes the base station event representation, as well as the wireless device events representation of type 33 corresponding to a call drop. Thus, one or more communication event type controls 114 enables the user to alter the selection of the event types 28 and the representation of the communication events 24 on map representation 44.

Further, in another aspect, user interface 108 may include one or more severity level controls 116 to be associated with each event representation on map 44. Severity level controls 116 correspond to severity levels 134 (also see FIG. 11), such as Low, Medium and High, and further correspond to severity thresholds 136 (FIG. 11), which may be user-defined values. Further, each severity level control 116 may correspond to a selection indicator 115, which determines if the respective severity level is selected or de-selected from inclusion in map representation 44. For example, selection indicator 115 may include, but is not limited to, inputting or removing a check from a checkbox. In one non-limiting case, for example, selection of one or more severity level controls 116 changes a characteristic of the corresponding representation of a wireless device or a base station on map representation 44 if the events associated with the representation exceed the respective severity threshold. As such, in an example of this case, checking the icon corresponding to a High severity level will cause any base station event representation and any wireless device events representation having a number of event occurrences exceeding the corresponding “high” threshold to be represented on map 44 with the defined characteristics of a high severity level, such as a red color in this case. Thus, one or more severity level controls 116 enables the user to alter the characteristics of the representation of the communication events 24 on map representation 44 based on severity thresholds.

Additionally, in a further aspect, user interface 108 may include one or more device representation controls 118 operable to control whether or not representations of communication events corresponding to a wireless device, or corresponding to a network device such as a base station, or both, are included in map representation 44. For example, in one case, since representations 46 (FIG. 1) and 52 (FIG. 1) are either a wireless device event representation or a base station representation, device representation controls 118 may include only one control that indicates the inclusion or exclusion of one or the other. In this case, device representation controls 118 include a “Call Failures” field that corresponds to wireless device events, as indicated by one or more icons 119 associated with selection indicator 115 to control the inclusion of representations of communication events occurring at a wireless device in map representation 44. For example, icons 119 may represent one or more event types 28 to be associated with each wireless device representation on map 44. Further, for example, icons 119 and/or event types 28 may correspond to a quality indicator of interest to a network operator, a wireless device manufacturer, a network device manufacturer, a wireless device or network device component manufacturer, etc., where such a quality indicator corresponds to an operational characteristic of the wireless device, the network device, or both. Additionally, icons 119 may relate to one or more data associated with each communication event 24 (FIG. 5), such as whether or not the respective event includes location data 35 (FIG. 5). In any case, in one example, un-checking “Call Failures” in this case will filter out all wireless device event representations from map 44, while the base station event representations will remain and will be associated with communication events according to the selected communication event type controls 114.

In a further example of one case, since each communication event 24 may be associated with both a wireless device and a network device such as a base station, representations 46 (FIG. 1) or 52 (FIG. 2), or both, on map 44 may include characteristics, such as an icon, a character, a color, etc., corresponding to one or more types 28 of communications events 24 included in the representation. Thus, one or more device representation controls 118 enables the user to define the representation of wireless devices, base stations, or both, and their corresponding communication events 24, on map representation 44.

Further, user interface 108 may optionally include other functional elements 121, such as a link to “unmapped failures” or to a “map settings” menu. In this respect, “unmapped failures” relate to communication events 24 that do not have associated location information, such as location 35, to allow the data to be represented on map 44. Further, “map settings” may include additional menu options to adjust the characteristics of map 44.

Therefore, user interface 108, which is one form of mapping interface 95 (FIG. 10), provides a convenient and flexible mechanism for a user to filter the representation of wireless devices and base stations, and corresponding communication event types, on map 44, as well as enabling the user to alter the characteristics of the representations depending on corresponding severity levels.

Referring again to FIGS. 13 and 14, the generation manager 40 may generate one or more workspace user interfaces 140 and 142 to provide an interactive workspace for a user to view map representations 44 and other detailed reports, discussed below, corresponding to requested communication events 24. For example, workspace user interfaces 140 and 142 may include a portion for user interface 108 and another portion for map representation 44, as well as one or more additional portions that may include various menus, tabs, drop-down menus, links, etc., for managing the display of communication event-related data. As previously noted, user interface 108 enables a user to change the determined area 34 illustrated by map representation 44, as well as controlling the representations associated with communication events. Further, workspace user interfaces 140 and 142 may additionally include a selection tool 144, such as a variable size box or circle, enabling a user to highlight portions of the determined area 34 to zoom in on or where additional detail is desired. Thus, workspace user interfaces 140 and 142 allow a user to generate requests for communication events, as well as analyze the data corresponding to the communication events and visualize the representations on a map.

Additionally, specifically referring to FIG. 14, generation manager 40 (FIG. 1) may generate map representation 44 including a notification 145 if communication event data related to a representation 147 on the map is not reflected in the respective representation or in the data linked to the representation in the given map view. For example, if representation corresponds to a base station and a portion of the cell serviced by the base station falls outside of the determined area, then in some aspects the communication events associated with the base station but occurring in the portion of the cell outside of the determined area may not be included in the view or in the data linked to the view. This situation may occur, for example, when a base station is located near the edge of determined area 34. Notification 145 may be a text, a graphic, a color, an audio warning, or any other mechanism operable to notify a user of the situation. It should be noted that in some aspects, notification 145 may represent the opposite case, e.g. that data corresponding to communication events located outside of determined area 34 but associated with a base station inside of area 34 are included in the displayed or linked information.

Referring to FIGS. 10 and 15, in another aspect, generation manager 40 may generate the representations for the communication events 24 based on binning rules 91 defining how to associate the events with different portions of the map 44. In one aspect, referring to FIG. 15, bins 122 provide a convenient mechanism to allow an orderly analysis of each communication event 24 falling within determined area 34. As such, the processing of representations within determined area 34 can be distributed based assigning each communication event 24 to a subset of determined area 34 as defined by each bin 122. Further, in one example, the respective communications events 24 in each bin 122 can then be represented individually, or in a combined manner based on representation rules 48 (FIG. 1). In another example, a single representation for each bin 122 may be generated.

For example, in FIG. 15, map representation 44 includes determined area 34 separated into a grid bins 122. It should be noted that the number of bins per area may vary depending on the application. In one aspect, for example for processing call failures for wireless devices and base stations, a grid size of 30×30 bins has been found to be an efficient grid size for use across a range of various sized predetermined areas 34. In other aspects, once determined area 34 is known, bins 122 are sized to contain only one representation, and thus any communication events falling within a respective bin 122 are automatically combined. Sizing bins in this manner may be especially helpful when the relative size of the representations remains substantially the same in any view. In other aspects, bins 122 may be sized based on usability for a pixel size of map representation 44. In other aspects, bins 122 may be sized so that if every bin 122 contains a communication event, then the estimated corresponding amount of data is equal to or less than a maximum amount of data, based on data throughput or processing capabilities, that can be passed from data collecting device 26 to monitoring device 22. It should be noted that any combination of these considerations may be used to determine a size of bins 122.

In one aspect, the generation manager 40 may generate a representation for the communication events 24 for the determined area 34 defining the map representation 44 in the following manner. First, each of the communication events 24 is associated with one of the plurality of bins 122. For example, based on the respective location 35 of the respective communication event 24, generation manager 40 associates each respective event within the geographic boundaries of a respective bin 122. Second, generation manager 40 determines if any overlaps 60 exceeding predetermined overlap threshold 50 exist between two or more representations in each bin 122 according to representation rules 48. For example, generation manager 40 may determine a first representation 46 (FIG. 1) for each communication event 24. The first representation 46 does not have to be explicit; the generation manager 40 may estimate the size and location of an icon on map representation 44. As such, the first representation 46 may be a default icon size. Further, the generation manager 40 checks if any two or more of the first representations 46 have overlap 60 (FIG. 2) exceeding predetermined overlap threshold 50. If so, then all the first representations 46 in each bin 12 that overlap beyond the allowed threshold are instead represented by second representation 52, which is a combined representation. As such, representations in each bin 122 may include one or more first representations 46 corresponding to a communication event 24, or one or more second representations 52 corresponding to a combination of communication events 24, or one or more of both first representations 46 and second representations 52. Thus, by using bins 122, the generation manager 40 may reduce the number of representations needed to be consumed by a user, and may further limit the number of communication events 24 needed to be examined to generate the second representation 52 for each bin 122.

In another aspect, generation manager 40 determines a minimum area, e.g. determined area 34, for map 44 that includes all of the communication events 24 to be displayed. As such, the geographic area of the map to be generated is dynamic, varying based on the extent of the locations of the communication events to be represented. Further, the apparatus and methods apply binning rules 91 to the determined map area 34, which divides up the determined area 34 into a plurality of bins 122. As such, the communication event data is analyzed on a bin-by-bin basis in order to determine how to represent the data. In one particular aspect, each bin 122 is sized to be about equal to or slightly larger than a size of the representation to be displayed on the map 44. As such, any communication events 24 falling within a respective bin 122 are automatically combined and presented in a combined representation. In other words, in this case, the sizing of the bin and the sizing of the representation are determined such that any communication event within any bin automatically has an individual representation that exceeds a predetermined overlap threshold, and thus the event data in each bin is automatically combined without having to individually determine an overlap amount one-by-one.

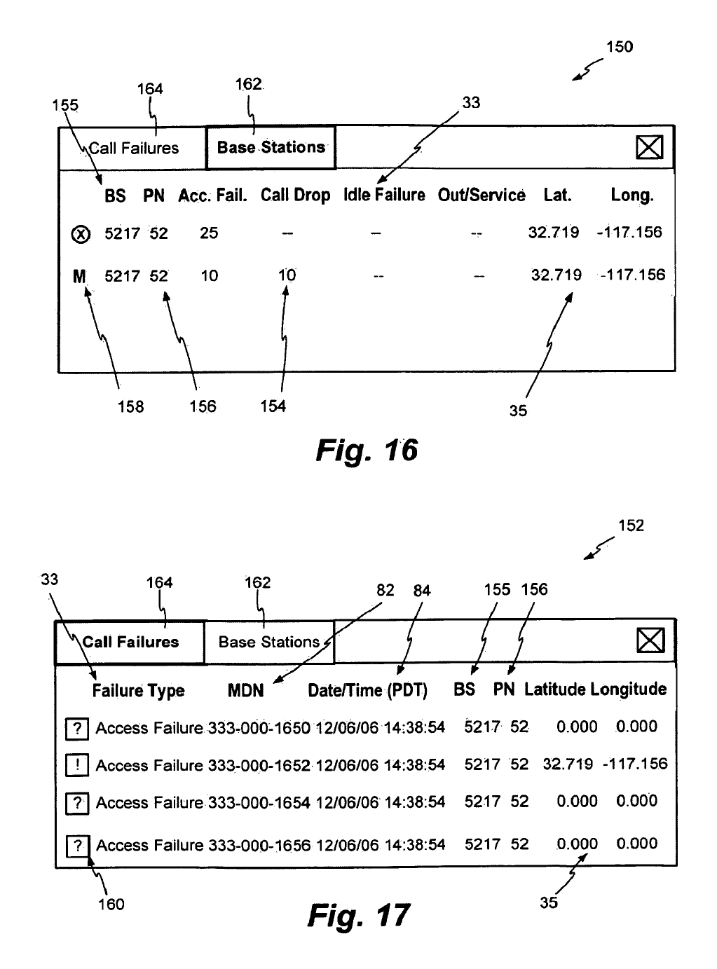

Additionally, referring to FIGS. 16 and 17, the generation manager 40 may generate one or more event reports 150 and 152 corresponding to the representation of communication events 24 on map 44. In one aspect, for example, reports 150 and 152 may be generated on map representation 44 after positioning a pointer over a combined representation, or after clicking on a combined representation. It should be noted that reports 150 and 152 also may be generated on other user interfaces, or printed out. In one example, referring to FIG. 16, report 150 provides a count 154 or value of the number of each event type 33 corresponding to a respective base station (BS) 155, as may be determined from network-related data 87 (FIG. 5). Additionally, in this example, report 150 includes location 35 such as a longitude and latitude, additional network-related data such as a pseudo-random number (PN) 156 that identifies a cell in a CDMA system, and visual indicator 109 of the event type filter 109 (FIG. 6) used for sorting event types 33 (FIG. 5) corresponding to communication events 24 (FIG. 5) associated with each respective base station 155. Further, report 150 includes menu tabs 162 and 164 that allow a user to switch between a base station menu 162, which is illustrated, and a call failure menu 164 (see FIG. 17), which includes corresponding details sorted based on wireless device-related data 81 (FIG. 5), such as MDNs, instead of base station identifiers.

So, for example, referring to FIG. 17, report 152 represents a detail of all event types 33, referred to as “Failure Types,” corresponding to communication events 24 occurring at each wireless device based on communication device ID 82, which is referred to as Mobile Directory Number (MDN) in this case, and further correlated to a respective network-related data 87 such as a base station (BS) 155 and/or pseudo-random number (PN) 156. Additionally, in this example, report 152 includes additional related data, such as location 35 including a longitude and latitude, a date/time 84, and a call failure icon 160, for example corresponding to the call failure option selected via communication event type controls 114 (FIG. 12) of user interface 108 (FIG. 12. Further, report 152 includes menu tabs 162 and 164 that allow a user to switch between call failure menu 164, which is illustrated, and the previously discussed base station menu 162.

Thus, reports 150 and 152 summary information may provide a convenient and efficient mechanism for a user to consume data corresponding to the representations of communication events 24 on map 44.

Therefore, generation manager 40 provides apparatus and methods for enhancing the presentation of communication events 24 by combining communication events 24 that would overlap by a predetermined overlap threshold 50 on the map representation 26, and alternatively, or in addition, in other aspects generation manager 40 enables the user to select how the combined presentation of the communication event 24 is represented, and alternatively or additionally allowing the user to select the determined area 34 to represent.

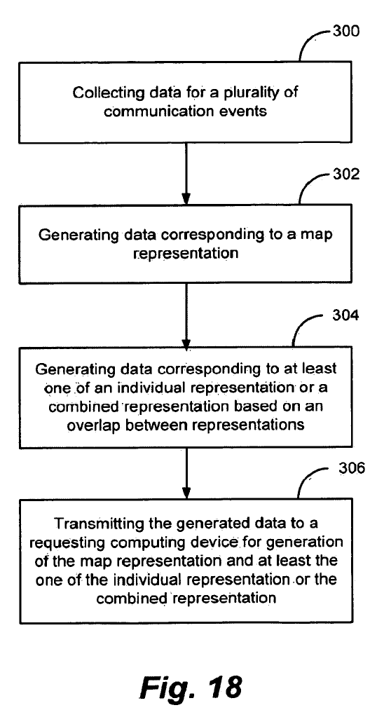

In operation, referring to FIG. 18, one aspect of a method of providing data related to a communication event occurring on a wireless device includes collecting data for a plurality of communication events (Block 300). In the method, each of the plurality of communication events respectively corresponds to a wireless device or a network device or both. Additionally, each communication event further corresponds to a respective location. The data for the plurality of communication events may be collected based on a request that defines one or more parameters or data associated with each of the plurality of communication data. Further, the data for the plurality of communication events may be collected from a resident memory or may be collected directly from the respective wireless device or network device corresponding to the requested data. Additionally, in some aspects, the plurality of communication events may be collected based on an event type or other communication device-related or network-related data characteristic associated with a respective communication event. Also, in some aspects when the data for communication events is combined, the collected data is based on a desired severity level associated with the combination of the data.

The method further includes generating data corresponding to a map representation (Block 302). In the method, the map representation has a determined area that corresponds to a geographic area defined by an extent of the respective locations. As such, the determined area of the map representation is a dynamically variable area depending on the locations of the communication events that are collected. Further, for example, the method may include generating or otherwise obtain image data corresponding to the determined area. As such, the generated data in this part of the method may be map image data. Additionally, in some aspects, this portion of the method may include calculating an extent of the respective locations associated with the requested communications events in order to obtain the determined area and generate map data corresponding to the determined area.

Also, the method includes generating data corresponding to at least one of an individual representation or a combined representation based on an overlap between representations (Block 304). In the method, each individual representation corresponds to one of the plurality of communication events, while each combined representation corresponds to a combination of at least two of the plurality of communication events if a predetermined overlap would exist between the respective individual representations of the at least two of the plurality of communication events on the map representation. In some aspects, the generated data comprises code executable by a presenting device to generate an image or representation on a display. Further, for example, the method may include generating or otherwise obtain image data corresponding to each individual representation or each combined representation, or both. As such, the generated data in this part of the method may be image data, for example, corresponding to a representation of a wireless device, a network device, or both. Further, each of the generated data corresponding to an individual representation or to a combined representation may relate to either a wireless device or to a network device. In some aspects, the generated representation data is processed according to representation rules that define an overlap threshold that can be used to determine when to generate data corresponding to the combined representation. In other aspects, the generated representation data is processed according to binning rules that define a number and/or size of an array of bins into which the determined area can be divided such that each communication event can be associated with one of the bins based on the respective location. In some aspects, the bins are sized based on the size of the representations, for example so that the bins are about the same size or slightly larger than the representations. In this case, if more than one communication event that is associated with the bin, then the method automatically generates combined data for a combined representation corresponding to each of the events within the respective bin.

Additionally, the method includes transmitting the generated data corresponding to a map representation and the generated data corresponding to at least one of an individual representation or a combined representation to a requesting computing device for generation of the map representation and at least the one of the individual representation or the combined representation (Block 306). For example, the generated data may be transferred over a communication network, such as the Internet.

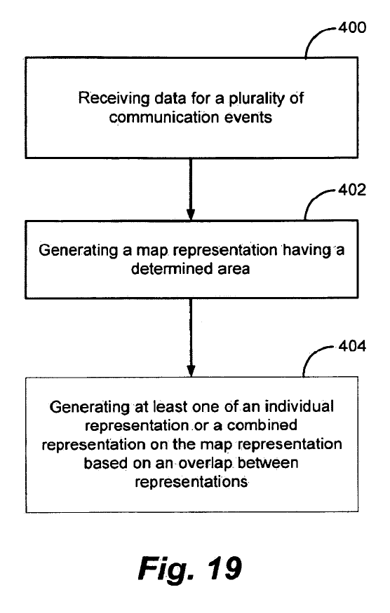

Referring to FIG. 19, one aspect of a method of presenting data related to a communication event occurring on a wireless device includes receiving data for a plurality of communication events (Block 400). In the method, each of the plurality of communication events respectively corresponds to a wireless device or a network device or both. Further, each communication event further corresponds to a respective location. The data for the plurality of communication events may be received based on a communication event request that defines one or more desired parameters associated with communication events to be received. As such, in some aspects, the data for plurality of communication events may be received based on a filtering parameter in the request. For example, the filter parameter may be an event type or other communication device-related or network-related data characteristic associated with a respective communication event. Also, in some aspects when the data for communication events is combined, the filtering parameter may be based on a desired severity level associated with the combination of the data.

Further, the method includes generating a map representation having a determined area (Block 402). In the method, the determined area corresponds to a geographic area defined by an extent of the respective locations. In some aspects, this portion of the method includes displaying image data corresponding to a map that has been received from another device. In other aspects, this portion of the method includes calculating the determined area and generating corresponding data resulting in a representation thereof.

Additionally, the method includes generating at least one of an individual representation or a combined representation on the map representation based on an overlap between representations (Block 403). In the method, each individual representation corresponds to one of the plurality of communication events. Further, each combined representation corresponds to a combination of at least two of the plurality of communication events if a predetermined overlap would exist between the respective individual representations of the at least two of the plurality of communication events on the map representation. In some aspects, this portion of the method includes displaying image data corresponding to each individual representation and each combined representation received from another device. In other aspects, this portion of the method includes generating the data and displaying the image. Further, in some aspects, the generated representation data is processed according to representation rules that define an overlap threshold that can be used to determine when to generate data corresponding to the combined representation. In other aspects, the generated representation data is processed according to binning rules that define a number and/or size of an array of bins into which the determined area can be divided such that each communication event can be associated with one of the bins based on the respective location. In some aspects, the bins are sized based on the size of the representations, for example so that the bins are about the same size or slightly larger than the representations. In this case, if more than one communication event that is associated with the bin, then the method automatically generates combined data for a combined representation corresponding to each of the events within the respective bin.

Additionally, in one example, the method of providing data related to a communication event may be operated by a server device, which transmits the generated data to a client device. Correspondingly, the method of presenting data related to a communication event may be operated by a client device that receives the data from the server device. Further, the client device can execute a client program, such as a web browser, operable to display the generated data as a map and as icons or other graphical indicators on the map.

Thus, the present apparatus and methods operate to enhance the presentation on a map of representations of communication events by combining representations that would overlap by a predetermined amount, and in additional or alternatively by allowing the user to configure how the combination of representations will be represented. Additionally, or alternatively, the presentation may be enhanced by combining the representations of communication events on a second computing device, and by retrieving the communication event data in a manner where a user process may continue to service user requests.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, at least one processor may include one or more modules operable to cause a computer to perform the steps and/or actions of any method or algorithm described herein. Additionally, in some aspects, the steps and/or actions of a method or algorithm may reside as one or any combination or set of instructions on a machine readable medium and/or computer readable medium included in a computer program product.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of providing data related to a communication event occurring on a wireless device, comprising:
collecting data for a plurality of communication events each respectively corresponding to a wireless device or a network device or both, wherein each communication event further corresponds to a respective location;
generating data corresponding to a map representation having a determined area, wherein the determined area corresponds to a geographic area defined by an extent of the respective locations;
generating data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation; and
transmitting the generated data corresponding to a map representation and the generated data corresponding to at least one of an individual representation or a combined representation to a requesting computing device for generation of the map representation and at least the one of the individual representation or the combined representation.

2. The method of claim 1, wherein generating data corresponding to at least one of the individual representation or the combined representation further comprises:
counting a number of event types associated with each communication event corresponding to the respective individual representation or the respective combined representation;
comparing the count to a corresponding severity threshold value; and
generating the data corresponding to the respective individual representation or the respective combined representation with one of a plurality of severity characteristics selected based on the comparing.

3. The method of claim 2, wherein the severity threshold value corresponds to a severity threshold level, and wherein transmitting the generated data corresponding to at least one of an individual representation or a combined representation further comprises only transmitting respective ones of the generated data corresponding to at least one of an individual representation or a combined representation associated with the severity threshold level based on the comparing.

4. The method of claim 1, wherein each of the plurality of communication events corresponds to one of a plurality of event types, and wherein transmitting the generated data corresponding to at least one of an individual representation or a combined representation further comprises transmitting respective ones of the generated data corresponding to at least one of an individual representation or a combined representation associated with one of the plurality of event types matching a requested event type.

5. The method of claim 1, wherein generating data corresponding to at least one of an individual representation or a combined representation further comprises:
dividing the determined area into a plurality of bins;
associating each of the plurality of communication events with one of the plurality of bins based on the respective location; and
generating data corresponding to a respective combined representation for any one of the plurality of bins associated with more than one of the plurality of communication events.

6. The method of claim 5, wherein the dividing is based on a data transmission capacity of the transmitting.

7. The method of claim 1, wherein generating data corresponding to at least one of an individual representation or a combined representation further comprises:
dividing the determined area into a plurality of bins based on a size on the map representation of a respective individual representation or a respective combined representation; and
associating each of the plurality of communication events with one of the plurality of bins based on the respective location.

8. The method of claim 1, wherein generating data corresponding to at least one of an individual representation or a combined representation further comprises:
dividing the determined area into a plurality of bins such that each bin has a bin size substantially corresponding to a size of a respective individual representation positioned on the map representation or a size of a respective combined representation positioned on the map representation; and
associating each of the plurality of communication events with one of the plurality of bins based on the respective location.

9. The method of claim 1, further comprising generating a new location for each combined representation based on each of the respective locations of the corresponding communication event data.

10. The method of claim 1, wherein transmitting further comprises adjusting a transmitted amount of the data based on a user activity level corresponding to activity on the requesting computing device.

11. The method of claim 1, wherein collecting further comprises gathering from a memory based on a communication event request received from the requesting computing device, and further comprising calculating the determined area based on the collecting.

12. The method of claim 1, wherein each individual representation corresponds to one of a respective wireless device or a respective network device, and wherein each combined representation corresponds to one of a respective combination of wireless devices or a respective combination of network devices.

13. The method of claim 1, wherein at least one combined representation corresponds to a respective combination of network devices associated with additional communication events having respective locations outside of the determined area, further comprising generating a notification of the additional communication events, and wherein the transmitting further comprises transmitting the notification.

14. At least one processor configured to provide data related to a communication event occurring on a wireless device, comprising:
a first module for collecting data for a plurality of communication events each respectively corresponding to a wireless device or a network device or both, wherein each communication event further corresponds to a respective location;
a second module for generating data corresponding to a map representation having a determined area, wherein the determined area corresponds to a geographic area defined by an extent of the respective locations;
a third module for generating data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation; and
a fourth module for transmitting the generated data corresponding to a map representation and the generated data corresponding to at least one of an individual representation or a combined representation to a requesting computing device for generation of the map representation and at least the one of the individual representation or the combined representation.

15. A computer program product configured to provide data related to a communication event occurring on a wireless device, comprising:
a computer-readable medium comprising:
at least one instruction for causing a computer to collect data for a plurality of communication events each respectively corresponding to a wireless device or a network device or both, wherein each communication event further corresponds to a respective location;
at least one instruction for causing the computer to generate data corresponding to a map representation having a determined area, wherein the determined area corresponds to a geographic area defined by an extent of the respective locations;
at least one instruction for causing the computer to generate data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation; and
at least one instruction for causing the computer to transmit the generated data corresponding to a map representation and the generated data corresponding to at least one of an individual representation or a combined representation to a requesting computing device for generation of the map representation and at least the one of the individual representation or the combined representation.

16. An apparatus configured to provide data related to a communication event occurring on a wireless device, comprising:
means for collecting data for a plurality of communication events each respectively corresponding to a wireless device or a network device or both, wherein each communication event further corresponds to a respective location;
means for generating data corresponding to a map representation having a determined area, wherein the determined area corresponds to a geographic area defined by an extent of the respective locations;
means for generating data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation; and
means for transmitting the generated data corresponding to a map representation and the generated data corresponding to at least one of an individual representation or a combined representation to a requesting computing device for generation of the map representation and at least the one of the individual representation or the combined representation.

17. A server device configured to provide data related to a communication event occurring on a wireless device, comprising:
a processor;
a memory in communication with the processor, wherein the memory is operable to store data for a plurality of communication events each respectively corresponding to a wireless device or a network device or both, wherein each communication event further corresponds to a respective location;
a download manager stored in the memory and executable by the processor, wherein the download manager is operable to generate data corresponding to a map representation having a determined area, wherein the determined area corresponds to a geographic area defined by an extent of the respective locations, wherein the download manager module is further operable to generate data corresponding to at least one of an individual representation or a combined representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation; and
a communications module operable to transmit the generated data corresponding to a map representation and the generated data corresponding to at least one of an individual representation or a combined representation to a requesting computing device for generation of the map representation and at least the one of the individual representation or the combined representation.

18. The server device of claim 17, wherein each communication event corresponds to one of a plurality of event types, wherein the memory further comprises a plurality of severity characteristics each corresponding to one of a plurality of severity threshold values, and wherein the download manager is further operable to:
count a number of event types associated with each respective individual representation or each respective combined representation;
compare the count to the plurality of severity threshold values; and
generate the data corresponding to the respective individual representation or the respective combined representation with a corresponding one of the plurality of severity characteristics selected based on the comparison.

19. The server device of claim 18, wherein each of the plurality of severity threshold values corresponds to one of a plurality of severity levels, and wherein the download manager is further operable to direct the communications module to transmit respective ones of the generated data corresponding to at least one of an individual representation or a combined representation associated with one of the plurality of severity levels matching a requested severity level.

20. The server device of claim 17, wherein each of the plurality of communication events corresponds to one of a plurality of event types, and wherein the download manager is further operable to direct the communications module to transmit respective ones of the generated data corresponding to at least one of an individual representation or a combined representation associated with one of the plurality of event types matching a requested event type.

21. The server device of claim 17, wherein the download manager further comprises a binning rule operable to cause the download manager to:
divide the determined area into a plurality of bins;
associate each of the plurality of communication events with one of the plurality of bins based on the respective location; and
generate data corresponding to a respective combined representation for any one of the plurality of bins associated with more than one of the at least two communication events.

22. The server device of claim 21, wherein the plurality of bins is further based on a data transmission capacity.

23. The server device of claim 17, wherein each respective individual representation or each respective combined representation further comprises a representation size on the map representation, and wherein the download manager further comprises a binning rule operable to cause the download manager to:
divide the determined area into a plurality of bins based on the representation size of a respective individual representation or a respective combined representation; and
associate each of the plurality of communication events with one of the plurality of bins based on the respective location.

24. The server device of claim 17, wherein each respective individual representation or each respective combined representation further comprises a representation size on the map representation, and wherein the download manager further comprises a binning rule operable to cause the download manager to:
divide the determined area into a plurality of bins such that each bin has a bin size substantially corresponding to the representation size of a respective individual representation or a respective combined representation; and
associate each of the plurality of communication events with one of the plurality of bins based on the respective location.

25. The server device of claim 17, wherein the download manager is further operable to generate a new location for each combined representation based on each of the respective locations of the corresponding communication event data.

26. The server device of claim 17, wherein the download manager is further operable to direct the communications module to adjust a transmitted amount of the data based on a user activity level corresponding to activity on the requesting computing device.

27. The server device of claim 17, wherein the communications module is further operable to receive a communication event request from the requesting computing device, wherein the communication event request defines the plurality of communication events, and wherein the download manager module is further operable to calculate the determined area based on the plurality of communication events defined by the communication event request.

28. The server device of claim 17, wherein each individual representation corresponds to one of a respective wireless device or a respective network device, and wherein each combined representation corresponds to one of a respective combination of wireless devices or a respective combination of network devices.

29. The server device of claim 17, wherein at least one combined representation corresponds to a respective combination of network devices associated with additional communication events having respective locations outside of the determined area, wherein the download manager module is further operable to generate a notification of the additional communication events, and wherein the communications module is further operable to transmit the notification with the transmission of the generated data.

30. A method of presenting data related to a communication event occurring on a wireless device, comprising:
receiving data for a plurality of communication events each respectively corresponding to a wireless device or a network device or both, wherein each communication event further corresponds to a respective location;
generating a map representation having a determined area, wherein the determined area corresponds to a geographic area defined by an extent of the respective locations; and
generating at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

31. The method of claim 30, wherein generating at least one of the individual representation or the combined representation further comprises:
counting a number of event types associated with each communication event corresponding to the respective individual representation or the respective combined representation;
comparing the count to a corresponding severity threshold value; and
generating the respective individual representation or the respective combined representation with one of a plurality of severity characteristics selected based on the comparing.

32. The method of claim 31, wherein the severity threshold value corresponds to a severity threshold level, and wherein generating at least one of the individual representation or the combined representation further comprises only generating respective ones of the at least one of an individual representation or a combined representation associated with the severity threshold level based on the comparing.

33. The method of claim 30, wherein each of the at least one of an individual representation or a combined representation corresponds to one of a plurality of event types, and wherein generating the at least one of an individual representation or a combined representation further comprises generating at least one representation associated with one of the plurality of event types matching a requested event type.

34. The method of claim 30, wherein each of the plurality of communication events corresponds to one of a plurality of event types, and wherein generating the at least one of an individual representation or a combined representation further comprises generating at least one representation associated with one of the plurality of event types matching a requested event type.

35. The method of claim 30, wherein generating at least one of an individual representation or a combined representation further comprises generating a respective combined representation for each of a plurality of bins into which the determined area is divided if the respective bin is associated with the respective location of more than one of the plurality of communication events.

36. The method of claim 30, wherein generating at least one of an individual representation or a combined representation further comprises:
dividing the determined area into a plurality of bins;
associating each of the plurality of communication events with one of the plurality of bins based on the respective location; and
generating a respective combined representation for any one of the plurality of bins associated with more than one of the at least two communication events.

37. The method of claim 36, wherein the dividing is based on a data transmission capacity of the receiving.

38. The method of claim 30, wherein generating at least one of an individual representation or a combined representation further comprises:
dividing the determined area into a plurality of bins based on a size on the map representation of a respective individual representation or a respective combined representation; and
associating each of the plurality of communication events with one of the plurality of bins based on the respective location.

39. The method of claim 30, wherein generating at least one of an individual representation or a combined representation further comprises:
dividing the determined area into a plurality of bins such that each bin has a bin size substantially corresponding to a size of a respective individual representation positioned on the map representation or a size of a respective combined representation positioned on the map representation; and
associating each of the plurality of communication events with one of the plurality of bins based on the respective location.

40. The method of claim 30, further comprising generating each combined representation in a new location based on each of the respective locations of the corresponding communication event data.

41. The method of claim 30, further comprising adjusting an amount of the data received during the receiving action or generated during either of the generating actions based on a user activity level corresponding to activity on the device performing the respective one of the receiving or the generating.

42. The method of claim 30, wherein the receiving action or either of the generating actions further comprise:
performing a portion of the respective one of the receiving or the generating for a first predetermined length of time;
comparing a user activity level of a user process to a predetermined user activity threshold after the first predetermined length of time; and
switching control to the user process if the user activity level exceeds the predetermined user activity threshold.

43. The method of claim 42, further comprising:
executing the user process until being in an idle state for a second predetermined length of time; and
switching control back to the respective one of the receiving or the generating after expiration of the second predetermined length of time.

44. The method of claim 30, wherein transmitting a communication event request to a data collecting device, wherein the communication event request defines the plurality of communication events received.

45. The method of claim 30, wherein each individual representation corresponds to one of a respective wireless device or a respective network device, and wherein each combined representation corresponds to one of a respective combination of wireless devices or a respective combination of network devices.

46. The method of claim 30, wherein at least one combined representation corresponds to a respective combination of network devices associated with additional communication events having respective locations outside of the determined area, and further comprising generating a notification of the additional communication events.

47. At least one processor configured for presenting data related to a communication event occurring on a wireless device, comprising:
a first module for receiving data for a plurality of communication events each respectively corresponding to a wireless device or a network device or both, wherein each communication event further corresponds to a respective location;
a second module for generating a map representation having a determined area, wherein the determined area corresponds to a geographic area defined by an extent of the respective locations; and
a third module for generating at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

48. A computer program product configured for presenting data related to a communication event occurring on a wireless device, comprising:
a computer readable medium, comprising:
at least one instruction for causing a computer to receive data for a plurality of communication events each respectively corresponding to a wireless device or a network device or both, wherein each communication event further corresponds to a respective location;
at least one instruction for causing the computer to generate a map representation having a determined area, wherein the determined area corresponds to a geographic area defined by an extent of the respective locations; and
at least one instruction for causing the computer to generate at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

49. An apparatus for presenting data related to a communication event occurring on a wireless device, comprising:
means for receiving data for a plurality of communication events each respectively corresponding to a wireless device or a network device or both, wherein each communication event further corresponds to a respective location;
means for generating a map representation having a determined area, wherein the determined area corresponds to a geographic area defined by an extent of the respective locations; and
means for generating at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

50. A client device for presenting data related to a communication event occurring on a wireless device, comprising:
a processor;
a memory in communication with the processor;
a retrieval module stored in the memory and executable by the processor, wherein the retrieval module comprises retrieval logic operable to cause the client device to receive data for a plurality of communication events each respectively corresponding to a wireless device or a network device or both, wherein each communication event further corresponds to a respective location;
a generation manager stored in the memory and executable by the processor, wherein the generation manager comprises generation logic operable to cause the client device to generate a map representation having a determined area, wherein the determined area corresponds to a geographic area defined by an extent of the respective locations, wherein the generation logic is further operable to cause the client device to generate at least one of an individual representation or a combined representation on the map representation, wherein each individual representation corresponds to one of the plurality of communication events, wherein each combined representation corresponds to a combination of at least two of the plurality of communication events if a predetermined overlap would exist between the respective individual representations of the at least two of the plurality of communication events on the map representation.

51. The client device of claim 50, wherein the generation logic is further operable to cause the client device to:
count a number of event types associated with each communication event corresponding to the respective individual representation or the respective combined representation;
compare the count to a corresponding severity threshold value; and
generate the respective individual representation or the respective combined representation with one of a plurality of severity characteristics selected based on the comparing.

52. The client device of claim 51, wherein the severity threshold value corresponds to a severity threshold level, and wherein the generation logic is further operable to cause the client device to only generate respective ones of the at least one of an individual representation or a combined representation associated with the severity threshold level based on the comparison.

53. The client device of claim 50, wherein each of the at least one of an individual representation or a combined representation corresponds to one of a plurality of event types, and wherein the generation logic is further operable to cause the client device to generate at least one representation associated with one of the plurality of event types matching a requested event type.

54. The client device of claim 50, wherein each of the plurality of communication events corresponds to one of a plurality of event types, and wherein the generation logic is further operable to cause the client device to generate at least one representation associated with one of the plurality of event types matching a requested event type.

55. The client device of claim 50, wherein the generation logic is further operable to cause the client device to generate a respective combined representation for each of a plurality of bins into which the determined area is divided if the respective bin is associated with the respective location of more than one of the plurality of communication events.

56. The client device of claim 50, wherein the generation logic is further operable to cause the client device to:
divide the determined area into a plurality of bins;
associate each of the plurality of communication events with one of the plurality of bins based on the respective location; and
generate a respective combined representation for any one of the plurality of bins associated with more than one of the at least two communication events.

57. The client device of claim 56, wherein the plurality of bins are based on a data transmission capacity.

58. The client device of claim 50, wherein the generation logic is further operable to cause the client device to:
divide the determined area into a plurality of bins based on a size on the map representation of a respective individual representation or a respective combined representation; and
associate each of the plurality of communication events with one of the plurality of bins based on the respective location.

59. The client device of claim 50, wherein the generation logic is further operable to cause the client device to:
divide the determined area into a plurality of bins such that each bin has a bin size substantially corresponding to a size of a respective individual representation positioned on the map representation or a size of a respective combined representation positioned on the map representation; and
associate each of the plurality of communication events with one of the plurality of bins based on the respective location.

60. The client device of claim 50, wherein the generation logic is further operable to cause the client device to generate each combined representation in a new location based on each of the respective locations of the corresponding communication event data.

61. The client device of claim 50, further comprising a trickle module comprising trickle logic operable to cause the client device to adjust an amount of the data respectively received or generated based on a user activity level corresponding to activity on the client device.

62. The client device of claim 50, further comprising a trickle module comprising trickle logic operable to cause the client device to:
perform a portion of the respective one of the receiving or the generating for a first predetermined length of time;
compare a user activity level of a user process to a predetermined user activity threshold after the first predetermined length of time; and
switching control to the user process if the user activity level exceeds the predetermined user activity threshold.

63. The client device of claim 62, wherein the trickle logic is further operable to cause the client device to:
execute the user process until being in an idle state for a second predetermined length of time; and
switch control back to the respective one of the receiving or the generating after expiration of the second predetermined length of time.

64. The client device of claim 50, wherein the retrieval logic is further operable to generate a communication event request for transmission to a data collecting device, wherein the communication event request defines the plurality of communication events received.

65. The client device of claim 50, wherein each individual representation corresponds to one of a respective wireless device or a respective network device, and wherein each combined representation corresponds to one of a respective combination of wireless devices or a respective combination of network devices.

66. The client device of claim 50, wherein at least one combined representation corresponds to a respective combination of network devices associated with additional communication events having respective locations outside of the determined area, and wherein the generation logic is further operable to cause the client device to generate a notification of the additional communication events.
